(19) United States
(12) Patent Application Publication
(10) Pub. No.: US 2003/0167226 A1
(43) Pub. Date: Sep. 4, 2003

(54) Method and system for improving fraud prevention in connection with a newly opened credit account

(75) Inventors: Randy Britton, Omaha, NE (US); Charles P. Sievers, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 10/091,605

(22) Filed: Mar. 4, 2002

(51) Int. Cl. G06F 17/60

(52) U.S. Cl. 705/38

(57) ABSTRACT

A system for managing newly opened credit accounts is provided. According to one aspect of the system, when a new credit account is opened in real-time, a set of restrictions is also applied to the new credit account in real-time. The set of restrictions can be provided by an issuer that issues the new credit account. The set of restrictions is designed to focus on a transaction incurred in connection with the new credit account and minimize any fraudulent activities until the new credit account is fully established. The new credit account can be fully established by executing a batch process. Upon fully establishing the new credit account, a fraud monitoring and prevention system can be used to take over detecting the fraudulent activities in connection with the new credit account.

### CROSS REFERENCES TO RELATED APPLICATION(S)

The present application is related to U.S. Provisional Patent Application Serial No. [to be assigned], entitled “METHOD AND SYSTEM FOR PROCESSING CREDIT CARD RELATED TRANSACTIONS,” by Zelechoski et al., filed on Mar. 4, 2002, and U.S. patent application Ser. No. [to be assigned], entitled “METHOD AND SYSTEM FOR PROCESSING CREDIT CARD PAYMENTS,” by Patton et al., filed on Mar. 4, 2002, both of which are commonly assigned and owned, the disclosures of which are hereby incorporated by reference in their entirety as if fully set forth herein for all purposes.

### BACKGROUND OF THE INVENTION

The present invention generally relates to credit accounts. More specifically, the present invention relates to a computerized method and system for managing credit accounts to minimize fraud.

The birth of a credit card generally begins with an applicant supplying information to complete a credit card application and apply for a credit account with an issuer or issuing bank. The issuer is usually a bank that issues the credit card and extends credit to the cardholder through the credit account linked to the credit card. Typically, the process of supplying the necessary information can be done electronically or by paper. The credit card application is then processed, and if approval criteria are met, a credit card is issued to the applicant who now becomes a cardholder. The process of issuing a credit card involves a number of steps including, for example, coding the credit card with cardholder data on the magnetic stripe and embossing the cardholder's name, account number and expiration date on the credit card.

When the credit card is first received by the cardholder, the cardholder needs to activate the credit card. Activation of the credit card is generally done by requiring the cardholder to call the issuer from his/her home phone. Once the credit card is activated, the cardholder may then use the credit card to make purchases or conduct transactions.

A typical credit card transaction involves a number of parties. In addition to the cardholder and the issuer, the parties involved in a credit card transaction include a merchant, an acquirer and a credit card association such as Visa or Mastercard. The acquirer is a business entity, e.g., a commercial bank, that has a business relationship with the merchant and handles credit card transactions from that merchant.

A typical credit card transaction involves the following steps. First, the merchant calculates the amount of the transaction or purchase and seeks payment from the cardholder. The cardholder then presents the merchant with his/her credit card. The merchant then runs the credit card through a point of sale terminal. The point of sale terminal captures credit card and sales information and sends such information together with an authorization request to the acquirer. The acquirer, in turn, processes the information received from the point of sale terminal and forwards any relevant information and the authorization request to the issuer. The issuer processes the relevant information and the authorization request to determine whether the transaction should be authorized. The issuer then sends an approval or denial code back to the acquirer. The acquirer relays the approval or denial code to the point of sale terminal for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. The remaining amount is then transferred by the acquirer to the merchant's account. The issuer also bills the cardholder for the transaction amount by sending the cardholder a credit card statement. The cardholder is typically billed by the issuer on a monthly cycle.

The foregoing is merely a general description of a typical credit card transaction. Variations and additional process(es) may be involved. It should also be understood that while certain parties, such as the issuer and the acquirer, are described above as performing certain functions, in typical situations, most or all of the functions to be performed by these parties may be performed on their behalf by third parties.

As described above, the cardholder typically receives a monthly credit card statement from the issuer detailing transactions which have been incurred in the previous month and the amount currently owed. Payment for the amount owed can be made by either check or online electronic fund transfer. The payment is then posted to the corresponding credit account. Under conventional practice, payment posted to a credit account does not have any immediate effect on that credit account. For example, the credit availability limit and the current amount owed do not accurately reflect the payment made until a later time. This is attributed to the fact that the payment processing is still being handled by computer systems which continue to utilize batch processing. FIG. 1 illustrates a general, conventional batch processing system which processes credit card payments. Payment information collected from online transactions 2 and batch files 4 are combined into a transaction file 6. The transaction file 6 is stored usually in the form of magnetic tapes. The batch processing system 8 then processes the transaction file 6 and generates various output files 10 which are then passed onto backend systems 12. The backend systems 12, in turn, make the appropriate adjustments to update the corresponding credit accounts.

Batch processing has proved to be inefficient and lacking in ability to provide real-time response or access. For example, since payment transactions are not processed in real-time, payments received for a credit account are generally not reflected until the transaction batch is run. The substantial latency between payment receipt and account update results in a number of disadvantages. For example, this latency may cause unnecessary inconvenience on the part of the cardholder. In one instance, despite having made a payment to his/her credit account, a cardholder may still risk having a transaction rejected since his/her credit account may not have been updated fast enough. In another instance, a collection agency may initiate collection procedures against a cardholder prematurely because the latest account information is not provided to the collection agency in a timely manner. Hence, it would be desirable to provide a computerized method and system which is capable of processing credit card payments in a more efficient manner.

In addition, with the widespread use of the Internet in electronic commerce, credit card applications are routinely submitted online and approvals, in a lot of cases, are granted within a short period of time, typically in a matter of minutes. Furthermore, along with the approval, a corresponding credit account is opened almost immediately and available for use by the account holder. A credit account opened in this matter is often referred to as instant credit account. Under conventional systems, an instant credit account only contains minimal information and a batch process still needs to be run to fully establish such credit account. For example, certain parameters need to be populated to allow fraud monitoring and prevention measures to become effective. Since these parameters are populated via the batch process, activation of the fraud monitoring and prevention measures is restrained by the execution of the batch process. Consequently, instant credit accounts are likely to be more susceptible to fraudulent activities. Hence, it would also be desirable to provide a computerized method and system which is capable of protecting instant credit accounts in a more efficient manner.

### SUMMARY OF THE INVENTION

A method and system for processing credit card payments is provided. According to one exemplary aspect of the system, a client is able to submit payment transactions in different formats for processing. A payment transaction may relate to a payment made to a corresponding credit account or a reversal which need to be performed to retract a previously made payment which is erroneous. Depending on the submission format, the system can process the payment transaction by using either a batch process or a right-time process. The right-time process processes the payment transaction in real-time upon submission thereby allowing the corresponding credit account to be updated in a more timely manner. In particular, the right-time process adjusts the available credit relative to the corresponding credit account in a real-time manner so that the available credit closely tracks or reflects payments made to the credit account.

Optionally, information relating to the available credit is provided to customer service to allow customer service representatives to better service the account holder. Furthermore, information relating to the payment transaction can also be provided to collections to allow collections agency to better manage delinquent accounts and provide improved services.

Furthermore, according to another exemplary aspect of the system, when a new credit account is opened in real-time, a set of restrictions is also applied to the new credit account in real-time. The set of restrictions can be provided by an issuer that issues the new credit account; alternatively, the set of restrictions can be a set of default restrictions provided by the system. The set of restrictions is designed to focus on a transaction incurred in connection with the new credit account and minimize any fraudulent activities until the new credit account is fully established. The new credit account can be fully established by executing a batch process. Upon fully establishing the new credit account, a fraud monitoring and prevention system is enabled to take over detecting the fraudulent activities in connection with the new credit account.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating a general, conventional batch processing system which processes credit card payment;

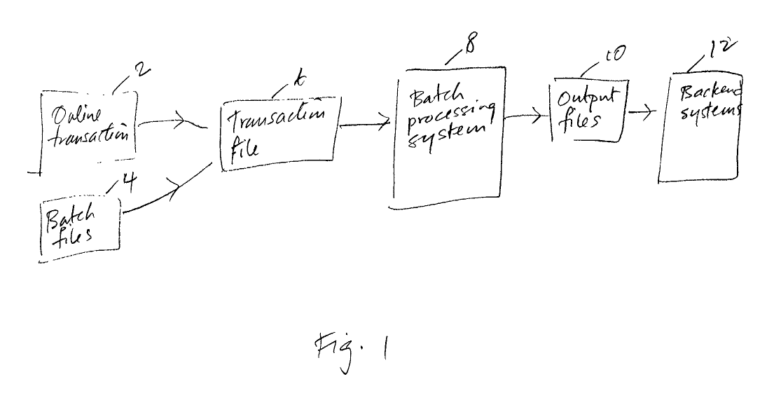

FIG. 2 is a flow diagram illustrating the operations of one aspect of an exemplary embodiment of the present invention; and

FIG. 3 is a flow diagram illustrating the operations of another aspect of an exemplary embodiment of the present invention.

### DETAILED DESCRIPTION OF THE INVENTION

The present invention in the form of one or more exemplary embodiments will now be described. An exemplary embodiment of the present invention is implemented as part of a computer system or infrastructure, such as the one described in U.S. patent application Ser. No. [to be assigned], entitled “METHOD AND SYSTEM FOR PROCESSING CREDIT CARD RELATED TRANSACTIONS,” by Zelechoski et al., filed on Mar. 4, 2002, and commonly assigned and owned, the disclosure of which is hereby incorporated by reference in its entirety as if fully set forth herein for all purposes. Based on the disclosure and teaching provided herein, a person of ordinary skill in the art would know of other ways and/or methods to implement the present invention.

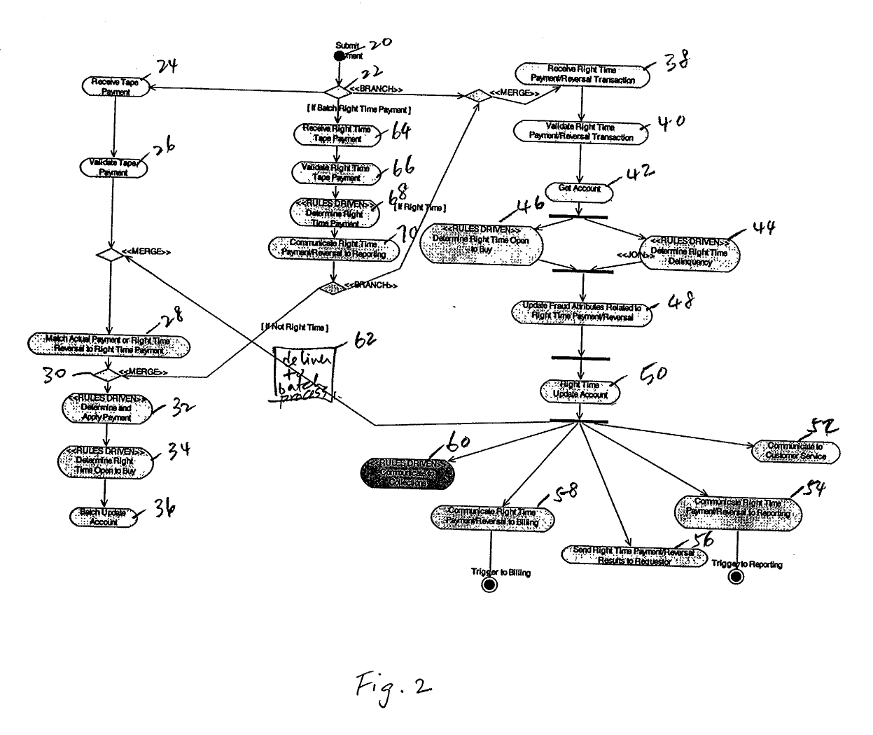

FIG. 2 is a flow diagram illustrating the operations of one aspect of an exemplary embodiment in accordance with the present invention. Prior to engaging step 20, payments are received by a client or user from account holders. Many different types of vehicles can be used to make a payment on a credit account including, for example, check, money order, cash, credit card, debit card, electronic fund transfer, wire transfer, coupon, etc. In addition, payments can be received from a number of different sources, such as, a teller, an ATM, a retailer, online banking and mail. The payments are first processed by the client or user. Relevant information for each payment is captured and put into the proper format in the form of a payment transaction. The payment transaction further includes other information relating to the client. A payment transaction created by the client or user is not limited to a payment received for an amount owed on a credit account but also includes any type of monetary transaction which may have an impact on the available credit or open-to-buy amount relating to that credit account. For example, a payment transaction can be generated by the client to represent a reversal reversing a previously paid amount that is erroneous.

It should be understood that, for illustrative purposes, while the operations of the exemplary embodiment is described with respect to an individual payment transaction submitted by a client, the present invention is similarly applicable to processing multiple payment transactions submitted by a number of different clients. Referring to FIG. 2, at 20, a payment transaction to be applied to the corresponding credit account is submitted by the client or user. A payment transaction can be submitted by the client or user in one of three ways. More specifically, the payment transaction can be submitted electronically or via one of two different types of tapes or other storage media. As described above, the client or user extracts the relevant information for each payment submitted by an account holder and incorporates such information into the proper format in a payment transaction. Such format includes, for example, an electronic format and two different types of tape formats. As will be more fully described below, depending on how the payment transaction is submitted by the client, either a right-time process or a batch process is invoked to process the payment transaction. At 22, the payment transaction submission method is verified to determine which process should be invoked to process the payment transaction.

A payment transaction submitted via a batch tape is referred to as a batch payment transaction. The batch process is invoked at a specific time to process the batch payment transactions contained in the batch tape. Typically, the batch process is initiated to process the batch tape at a designated time each day. Upon initiation, the batch process operates as follows. At 24, the batch payment transaction is received or read from the batch tape. At 26, the batch payment transaction is validated to ensure that the batch payment transaction can be processed. At 28, the batch payment transaction is matched up with a right-time payment transaction, if any. As will be further explained below, processed right-time payment transactions are delivered to the batch process. This step is performed to ensure that duplicate entries are not processed against the same credit account. It should be understood that in an alternative exemplary embodiment, this step may not be performed depending on how batch payment transactions and right-time payment transactions are organized and submitted. For example, if the batch payment transactions and the right-time payment transactions are mutually exclusive of each other, then this step 28 need not be performed. After 28, at 30, payment transactions from a right-time tape are inserted into the batch process for processing. The insertion of payment transactions from the right-time tape will be further described below. At 32, the batch payment transaction is applied against the corresponding credit account. For example, the payment amount can be divided and applied to various portions of the account balance. At 34, the available credit or open-to-buy amount is adjusted based on the applied payment amount of the batch payment transaction. The payment amount of the batch payment transaction to be applied to the available credit varies depending on a number of factors, such as, the attributes or conditions of the credit account. For example, if the credit account has a history of bounced check payments and the payment amount is made in check, then the available credit may not be adjusted until the check is cleared. On the other hand, if the payment amount was made in cash, then the full payment amount may be applied to the available credit. In another example, the amount of available credit to be adjusted is determined by an external system in order to minimize fraud. At 36, the corresponding credit account is updated.

If the payment transaction is submitted via either the right-time tape or the electronic format, then the right-time process is invoked to process the payment transaction in real-time. A payment transaction submitted and processed in the foregoing manner is referred to as a right-time payment transaction. The right-time process differs from the batch process in that the right-time process is invoked immediately or as soon as practicable upon receipt of a right-time payment transaction.

A right-time payment transaction can be submitted electronically. For example, a client or user may submit right-time payment transactions for processing via a computer network, such as the Internet, or a dedicated communication link, such as a T1 trunk. At 38 a right-time payment transaction is received and verified to insure that the right-time payment transaction is in the proper format.

At 40 the right-time payment transaction is validated to ensure that the right-time payment transaction can be processed. As part of this validation process, a number of validation checks are performed. For example, if a right-time payment transaction relates to a reversal, i.e., a previously made payment is to be retracted, then a match is performed in an attempt to match this right-time payment transaction against the previous right-time payment transaction relating to the previously made payment. If no match is found, the right-time payment transaction is declined and not processed. In addition, the right-time payment transaction is checked to make sure that the client who submitted the right-time payment transaction is authorized to conduct activities relative to the credit account identified by the right-time payment transaction. Moreover, the right-time payment transaction is also checked to ensure that the client number, the credit account number and the payment amount are valid. It should be understood that, in addition to the foregoing, other validation checks may also be performed.

At 42, the corresponding credit account (and the associated information) for that right-time payment transaction is retrieved. Then, using the retrieved information, the status of the credit account is evaluated to determine how the right-time payment transaction is to be applied.

At 44, the delinquency status of the credit account is determined. If the credit account is currently delinquent, then the right-time payment transaction is applied to the delinquent amount. If the right-time payment transaction relates to a payment, then the delinquent amount is decremented by the payment amount. If the payment amount is greater than or equal to the delinquent amount, then the delinquent status is changed to reflect that the credit account is no longer delinquent and the number of days delinquent is adjusted to zero. On the other hand, if the right-time payment transaction relates to a reversal (at this point, this right-time payment transaction matches up with a previous right-time payment transaction because it passed the validation check) and the previous right-time payment transaction brought the credit account out of delinquency, then the delinquency status, the delinquency amount and the number of days delinquent are restored to their respective values prior to the previous right-time payment transaction. In other words, the credit account is rendered delinquent due to reversal or retraction of the previously made payment.

At 46, the right-time payment transaction is applied to the available credit or open-to-buy amount. The available credit is adjusted upward or downward based on whether the right-time payment transaction relates to a payment or a reversal. When applying the right-time payment transaction to the available credit, the available credit will not be increased beyond a preset credit line assigned to that credit account. Furthermore, as mentioned above, the payment amount of the right-time payment transaction to be applied to the available credit varies depending on a number of factors, such as, the attributes or conditions of the credit account. For example, if the credit account has a history of bounced check payments and the payment amount is made in check, then the available credit may not be adjusted until the check is cleared. On the other hand, if the payment amount was made in cash, then the full payment amount may be applied to the available credit. Similarly, based on evaluation of the factors, portions of the payment amount may be applied to the available credit accordingly.

At 48, fraud attributes relating to the right-time payment transaction are updated. For example, one of the attributes that is updated reflects the number of days since the last payment was applied to the credit account. If the right-time payment transaction relates to a payment, this attribute is reset to zero to reflect the payment that has just been made. Another attribute that is updated reflects the aggregate amount of payments that were made within a preceding period, for example, the last 30 days. If the right-time payment transaction relates to a payment, this attribute is incremented to include the payment amount identified in the right-time payment transaction. On the other hand, if the right-time payment transaction relates to a reversal, this attribute is decremented accordingly. Optionally, these updated fraud attributes can be supplied by a computerized system, such as, a system called “Falcon” sold by HNC, or other commercially available systems, to allow account activities to be analyzed for purposes of detecting and preventing fraud.

At 50, the corresponding credit account is updated. After the credit account is updated, a number of other functions are also performed by the right-time process. Optionally, these other functions can be performed in either a serial or a parallel manner. For example, at 52, the updated account information pertaining to the updated credit account is communicated to customer service which is usually made available customer service representatives via customer service screens. By providing this updated information to customer service, customer service representatives may then, in turn, convey the latest account information to the cardholder in the event of an inquiry.

At 54, information relating to the processed right-time payment transaction is delivered to a reporting function which compiles information and reports relating to all the processed right-time payment transactions.

At 56, the information relating to the processed right-time payment transaction is also delivered to the client or user who submitted the right-time payment transaction for processing to notify the client of the result of the processed right-time payment transaction. For example, the client is informed of a right-time payment transaction that has been rejected due to a failed validation check or a right-time payment transaction relating to a reversal that has been rejected due to non-existence of a matching previous right-time payment transaction.

At 58, the information relating to the processed right-time payment transaction is communicated to a billing function which keeps track of the number of processed right-time payment transactions for the client or user for billing purposes.

At 60, the updated account information pertaining to the updated credit account is also communicated to collections. The updated account information may be provided in the form of an action entry, a collection memo or an external collection source file which is specific to the client submitting the right-time payment transaction. The external collection source file may include fields, such as, account number, date, amount, payment source, payment type, input source, time and transaction type. Optionally, the updated account information can be fed to a computerized collections system whose primary function is to initiate and coordinate collections actions. Such computerized collections system may be custom developed or provided by a commercial vendor. By providing this updated information to collections, collection agents may then more appropriately adjust their plan of action relating to the corresponding credit account. For example, armed with the latest account information, a collection agent may call the cardholder to thank the cardholder for his/her payment as opposed to demanding payment which had already been made.

Furthermore, after the corresponding credit account is updated, at 62, the pertinent information is delivered to the batch process for reconciliation to eliminate duplicate entries made against the same credit account. As mentioned above, this step is optional depending on how the batch payment transactions and the right-time payment transactions are organized.

As mentioned above, the right-time payment transaction can also be submitted via a right-time tape. The right-time tape differs from the batch tape in that the right-time tape is processed immediately or as soon as practicable upon submission. At 64, a right-time payment transaction from the right-time tape is received. At 66, the right-time payment transaction is validated to ensured that this right-time payment transaction can be processed. At 68, the right-time payment transaction is checked to determine whether the right-time process should be initiated to process this right-time payment transaction. It should be noted that, in some instances, only some (or none) of the payment transactions contained on the right-time tape may need to be processed by the right-time process. In other words, the right-time payment transactions which are to be processed are selectively extracted from the right-time tape. Hence, the client can selectively designate which of the payment transactions, if any, on the right-time tape are to be processed by the right-time process. At 70, information relating to the extracted right-time payment transactions is communicated to a reporting function which, amongst other things, complies and reports information relating to the extracted right-time payment transactions. The extracted right-time payment transactions are then put into the appropriate format and delivered to the right-time process for processing at 38, as described above. Since the right-time tape may contain payment transactions which are not designated for processing by the right-time process, these payment transactions (since they have already been validated) can now be inserted into the batch process, at 30 as previously mentioned, to await processing.

It should be understood that while the above is described with respect to an individual credit account, it will be appreciated by a person of ordinary skill in the art that the present invention can be applied to relationship credit accounts, such as, family member accounts and corporate accounts, and that the present invention can also be applied to other types of accounts.

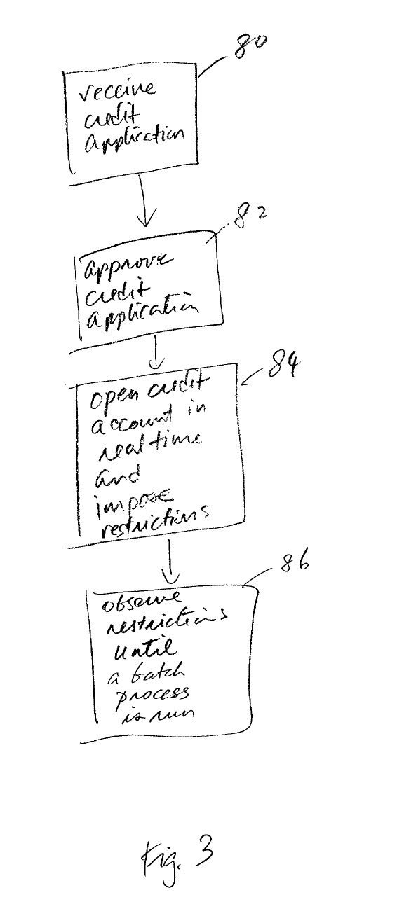

FIG. 3 is a flow diagram illustrating the operations of another aspect of an exemplary embodiment in accordance with the present invention. At 80, an applicant completes and submits a credit application to apply for a credit account. The completion and submission of the credit application may be achieved electronically online. At 82, upon reviewing the applicant's information provided in the credit application as well as information from other sources, such as a credit reporting bureau, the credit application is either approved or rejected in real-time. If the credit card application is approved, a credit account is opened in real-time. The approval may then be conveyed to the applicant immediately. For example, if the applicant applies for the credit account online, the approval can be relayed to the applicant in the same communication session; alternatively, the applicant may be contacted, for instance, by telephone. In any event, upon receiving the approval, the applicant, now the account holder, can begin using the newly opened credit account.

At 84, when opening the credit account, certain restrictions are concurrently placed on the credit account in real-time. These restrictions are used because the newly opened credit account is not yet fully established to allow fraud monitoring and prevention measures to effectively keep track of such credit account. At 86, these restrictions with respect to the newly opened credit account are observed until the newly opened credit account is fully established. A batch process may be run at a designated time in a processing cycle to fully establish the newly opened credit account. A newly opened account is considered fully established when all the relevant information and parameters are recorded against the account. For example, certain parameters relating to the newly opened credit account may need to be populated or established to enable the fraud monitoring and prevention measures to effectively monitor such credit account. Such parameters include, for example, home address, home phone number, zip code and open date. An example of a system which offers fraud monitoring and prevention measures is a system called “Falcon” sold by HNC. Hence, before the batch process is run, these restrictions are instituted to minimize fraudulent activities. Once the batch process is run, the fraud monitoring and prevention measures may take over to monitor the activities of the newly opened credit account.

The restrictions imposed on the newly opened credit account may vary. For example, these restrictions may be issuer-specific. That is, the issuer who issues the newly opened credit account may utilize its own restrictions to govern its credit accounts. Alternatively, a system which is capable of imposing such restrictions may utilize a set of default restrictions when issuer-specific restrictions are not available. For instance, a system may be capable of opening new credit accounts for various issuers. One or more of the issuers using this system may choose to provide their own restrictions when new credit accounts are opened on their behalf; other issuers may choose to use the set of default restrictions offered by the system.

The restrictions are designed to, preferably, focus on an individual transaction. Restrictions are typically driven to focus on merchant type (Internet gambling, etc.), account type (Gold v. Platinum v. Classic v. Cobranded) and transaction type (cash v. merchandise purchase). For example, one restriction may limit the transaction amount for each individual transaction to a percentage of the available credit, such as, limiting a single transaction amount limit to 50% of the available credit. Another restriction may limit the type of transaction which may be incurred with the newly opened credit account. For instance, transactions involving Internet adult entertainment or gambling may not be allowed. A person of ordinary skill in the art will know how to design such restrictions using other types of information in accordance with the present invention.

Consequently, when an account holder attempts to use the newly opened credit account in violation of any of the restrictions, the requested transaction will not be authorized thereby minimizing any fraudulent activities. More generally, an activity on a newly opened credit account can be authorized, or declined, or referred to a live agent for decision (i.e., obtain additional information before the approve/decline decision is made). Also, the recently incurred activity can also be queued up for review by a fraud analyst so as to allow possible followup with the account holder to verify that the incurred transaction was legitimate thereby possibly limiting (or stop limiting) further activity on the account.

It should also be understood that the present invention may be implemented in the form of control logic using software, hardware, or a combination of both, in a modular or integrated manner. The present invention can be implemented as a stand-alone system or as part of a larger computer system. Based on the disclosure provided herein, a person of ordinary skill in the art will know of other ways and/or methods to implement the present invention.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for managing newly opened credit accounts, comprising:
control logic configured to approve and open a new credit account in real-time; and
control logic configured to impose one or more restrictions on the new credit account in real-time when the new credit account is opened, the one or more restrictions being designed to focus on a transaction incurred with the new credit account;
wherein the one or more restrictions are used to minimize fraudulent activities until the new credit account is fully established.

2. The system of claim 1 further comprising:
control logic configured to execute a batch process at a designated time in a processing cycle to fully establish the new credit account.

3. The system of claim 2 wherein upon fully establishing the new credit account, a fraud monitoring and prevention system is able to take over detecting the fraudulent activities in connection with the new credit account.

4. The system of claim 1 wherein if any of the one or more restrictions is violated, authorization to use the new credit account is denied.

5. The system of claim 1 wherein the one or more restrictions are provided by an issuer of the new credit account.

6. The system of claim 1 wherein the one or more restrictions include a limit on allowable transaction amount for each individual transaction incurred in connection with the new credit account.

7. The system of claim 6 wherein the allowable transaction amount is limited to a percentage of available credit assigned for the new credit account.

8. The system of claim 1 wherein the one or more restrictions include a limit on type of transaction that is allowable under the new credit account.

9. The system of claim 1 wherein the system is implemented using software or hardware or a combination of both.

10. A system for managing newly opened credit accounts, comprising:
control logic configured to approve and open a new credit account in real-time;
control logic configured to apply a set of restrictions to the new credit account in real-time upon opening of the new credit account; and
control logic configured to execute a process at a designated time in a processing cycle to fully establish the new credit account;
wherein the set of restrictions is designed to focus on a transaction incurred with the new credit account and used to minimize fraudulent activities until the new credit account is fully established.

11. The system of claim 10 further comprising:
control logic configured to select the set of restrictions to be applied to the new credit account from a plurality of sets of restrictions.

12. The system of claim 11 wherein the plurality of sets of restrictions includes a set of restrictions provided by an issuer of the new credit account and a set of default restrictions.

13. The system of claim 10 wherein the process to be executed to fully establish the new credit account is a batch process.

14. The system of claim 10 wherein upon fully establishing the new credit account, a fraud monitoring and prevention system is able to take over detecting the fraudulent activities in connection with the new credit account.

15. The system of claim 10 wherein if any of the set of restrictions is violated, authorization to use the new credit account is denied.

16. The system of claim 10 wherein the set of restrictions includes a limit on allowable transaction amount for each individual transaction incurred in connection with the new credit account.

17. The system of claim 19 wherein the allowable transaction amount is limited to a percentage of available credit assigned for the new credit account.

18. The system of claim 10 wherein the set of restrictions includes a limit on type of transaction that is allowable under the new credit account.

19. A method for managing newly opened credit accounts, comprising:
approving and opening a new credit account in real-time; and
upon opening the new credit account, applying a set of restrictions to the new credit account in real-time, the set of restrictions being designed to focus on a transaction incurred with the new credit account and minimize fraudulent activities until the new credit account is fully established.

20. The method of claim 19 further comprising:
executing a batch process at a designated time in a processing cycle to fully establish the new credit account.

21. The method of claim 20 further comprising:
upon fully establishing the new credit account, enabling a fraud monitoring and prevention system to take over detecting the fraudulent activities in connection with the new credit account.

22. The method of claim 19 further comprising:
if a restriction within the set of restrictions is violated, denying an authorization to use the new credit account.

23. The method of claim 19 wherein the set of restrictions is provided by an issuer of the new credit account.

24. The method of claim 19 wherein the set of restrictions includes a limit on allowable transaction amount for each individual transaction incurred in connection with the new credit account.

25. The method of claim 24 wherein the allowable transaction amount is limited to a percentage of available credit assigned for the new credit account.

26. The method of claim 19 wherein the set of restrictions includes a limit on type of transaction that is allowable under the new credit account.

27. A method for managing newly opened credit accounts, comprising:
approving and opening a new credit account in real-time;
applying a set of restrictions to the new credit account in real-time upon opening of the new credit account; and
executing a process at a designated time in a processing cycle to fully establish the new credit account;
wherein the set of restrictions is designed to focus on a transaction incurred with the new credit account and used to minimize fraudulent activities until the new credit account is fully established.

28. The method of claim 27 further comprising:
selecting the set of restrictions to be applied to the new credit account from a plurality of sets of restrictions.

29. The method of claim 28 wherein the plurality of sets of restrictions includes a set of restrictions provided by an issuer of the new credit account and a set of default restrictions.

30. The method of claim 27 wherein the process to be executed to fully establish the new credit account is a batch process.

31. The method of claim 27 further comprising:
upon fully establishing the new credit account, enabling a fraud monitoring and prevention system to take over detecting the fraudulent activities in connection with the new credit account.

32. The method of claim 27 further comprising:
if any of the set of restrictions is violated, denying an authorization to use the new credit account.

33. The method of claim 27 wherein the set of restrictions includes a limit on allowable transaction amount for each individual transaction incurred in connection with the new credit account.

34. The method of claim 33 wherein the allowable transaction amount is limited to a percentage of available credit assigned for the new credit account.

35. The method of claim 27 wherein the set of restrictions includes a limit on type of transaction that is allowable under the new credit account.
